(19) United States
(12) Patent Application Publication
(10) Pub. No.: US 2006/0143375 A1
(43) Pub. Date: Jun. 29, 2006

(54) Content addressable memory with shared comparison logic

(76) Inventor: Bharadwaj Pudipeddi, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/027,729

(22) Filed: Dec. 29, 2004

(51) Int. Cl. G06F 12/00

(52) U.S. Cl. 711/108

(57) ABSTRACT

Techniques for sharing comparison logic in content addressable memories are disclosed. In one embodiment, a content addressable memory includes a first entry location and a second entry location. The first entry location includes a first plurality of cells and first comparison logic. The second entry location includes a second plurality of cells, second comparison logic, and first match logic. The first plurality of cells is to store a high order portion of a first entry, and the second plurality of cells is to store a low order portion of a second entry. The first comparison logic is to indicate whether a first condition is true, where the first condition is whether a first portion of look-up data matches the high order portion of the first entry. The second comparison logic is to indicate whether a second condition is true, where the second condition is whether a second portion of look-up data matches the low order portion of the second entry. The first match logic is to indicate whether both the first and the second conditions are true.

### BACKGROUND

1. Field

The present disclosure pertains to the field of data processing and, more specifically, to the field of content addressable memories (“CAMs”) in microprocessors and other data processing apparatuses.

2. Description of Related Art

CAMs are used in applications where entries are identified, or “looked-up,” based on their contents instead of their addresses. These applications include caches and translation look-aside buffers.

In a typical configuration, CAM look-ups are implemented in dynamic logic. A match to a CAM entry is indicated by a logical high state on a hit line that is pre-charged high in one phase of the clock, and conditionally discharged by one or more CAM cells in the other phase. Each CAM cell corresponds to one bit of one CAM entry, and includes a pull-down transistor controlled by a comparator. The comparator turns the pull-down transistor on when the CAM entry bit does not match the corresponding look-up bit.

In this typical configuration, every cell of every entry must be checked on a look-up. However, in most applications where CAMs are used, there are only a few matches per look-up, usually no more than one. Therefore, almost every CAM look-up requires charging an aggregate load proportional to the number of entries times the number of bits per entry, and discharging virtually the entire load. Consequently, CAMs may account for a significant portion of the power consumed by high performance microprocessors.

### BRIEF DESCRIPTION OF THE FIGURES

The present invention is illustrated by way of example and not limitation in the accompanying figures.

FIG. 1 illustrates an embodiment of a set associative cache having shared comparison logic.

FIG. 2 illustrates an embodiment of a fully associative translation look-aside buffer having shared comparison logic.

FIG. 3 illustrates a primary and a prevalidated entry of the embodiment of FIG. 2 in greater detail.

FIG. 4 illustrates a CAM cell of the embodiment of FIG. 2 in greater detail.

FIG. 5 illustrates an embodiment of a method for sharing comparison logic in a set associative cache.

FIG. 6 illustrates an embodiment of a method for sharing comparison logic in a fully associative translation look-aside buffer.

FIG. 7 illustrates an embodiment of a system having a CAM with shared comparison logic.

### DETAILED DESCRIPTION

The following description describes embodiments of techniques for sharing the comparison logic in a CAM. In the following description, numerous specific details, such as logic and circuit configurations, are set forth in order to provide a more thorough understanding of the present invention. It will be appreciated, however, by one skilled in the art, that the invention may be practiced without such specific details. Additionally, some well known structures, circuits, and the like have not been shown in detail, to avoid unnecessarily obscuring the present invention.

Embodiments of the present invention provide techniques for sharing the comparison logic in a CAM, and may be applied to any CAM used in any application, including caches and translation look-aside buffers. Accordingly, the data stored in a CAM using these techniques may be any type of information, including memory addresses, represented by binary digits or in any other form. A CAM using these techniques may have any number of entries and any number of bits per entry, and may be functionally organized according to any known approach. For example, the CAM may be organized into two sections, one for match content and one for payload content, where the match content is the data to be compared to the data presented to the CAM for look-up (the “look-up data”), and the payload content is the data to be delivered if there is a hit to the corresponding match content. Alternatively, the CAM may have no payload section, and instead be organized to deliver the match content itself, or simply an indicator of whether or not there is a match.

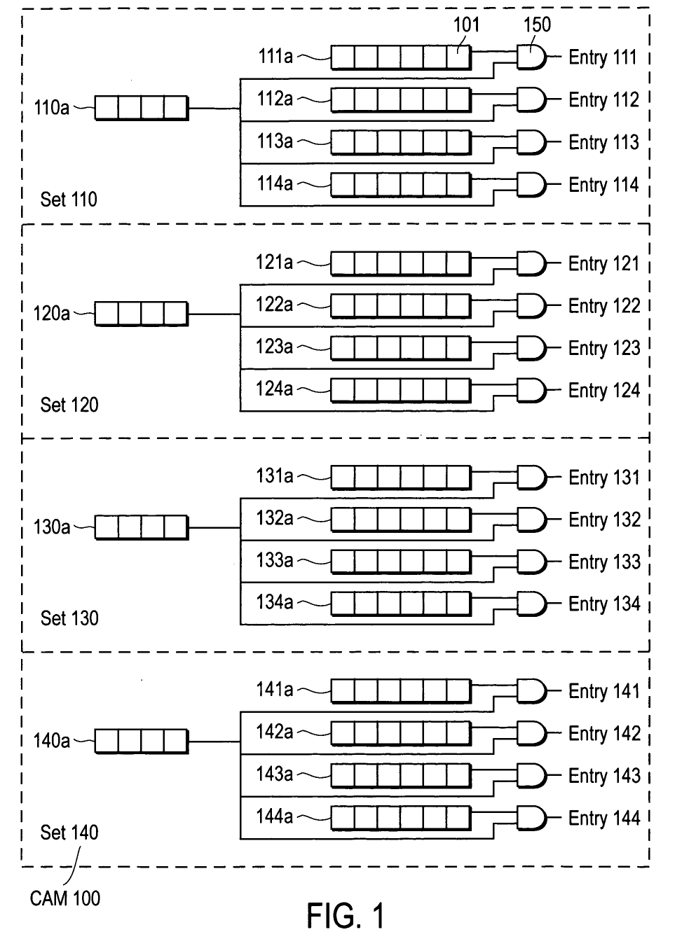

FIG. 1 illustrates an embodiment of a CAM 100 having shared comparison logic. In this embodiment, CAM 100 is a four-way set associative cache having sixteen entry locations to store ten-bit tag addresses. Set 110 includes entry locations 111, 112, 113, and 114; set 120 includes entry locations 121, 122, 123, and 124. Set 130 includes entry locations 131, 132, 133, and 134. Set 140 includes entry locations 141, 142, 143, and 144.

Every entry location includes six CAM cells 101 to store the six least significant bits of a tag address. However, the four entry locations in each set share four CAM cells 101 to store the four most significant bits of a tag address. For example, entry locations 111, 112, 113, and 114 include lower portions 111a, 112a, 113a, and 114a, respectively, but share upper portion 110a.

When an entry is loaded into the cache, the four most significant bits of the tag address are compared to the contents of the upper portion for the set into which the entry is loaded. For example, for an entry to be placed into entry location 111, the four most significant bits of the tag address are compared to the contents of upper portion 110a. If there is a match, then the six least significant bits of the tag address are loaded into lower portion 11a, and upper portion 110a and entries 112, 113, and 114 are not changed. However, if there is not a match, then the six least significant bits of the tag address are loaded into lower portion 111a, the four most significant bits are loaded into upper portion 110a, and entries 112, 113, and 114 are invalidated.

On a look-up, the four most significant bits of the look-up data are compared to the contents of all of the four upper portions 110a, 120a, 130a, and 140a, and the six least significant bits are compared to the contents of all of the sixteen lower portions 111a, 112a, 113a, 114a, 121a, 122a, 123a, 124a, 131a, 132a, 133a, 134a, 141a, 142a, 143a, and 144a. AND gates 150 indicate whether there is a hit to any of the lower portions and its corresponding upper portion. Therefore, on a look-up, the dynamic power consumed by the comparison logic for the most significant bits is only one-fourth of what it would be if every entry had its own comparison logic.

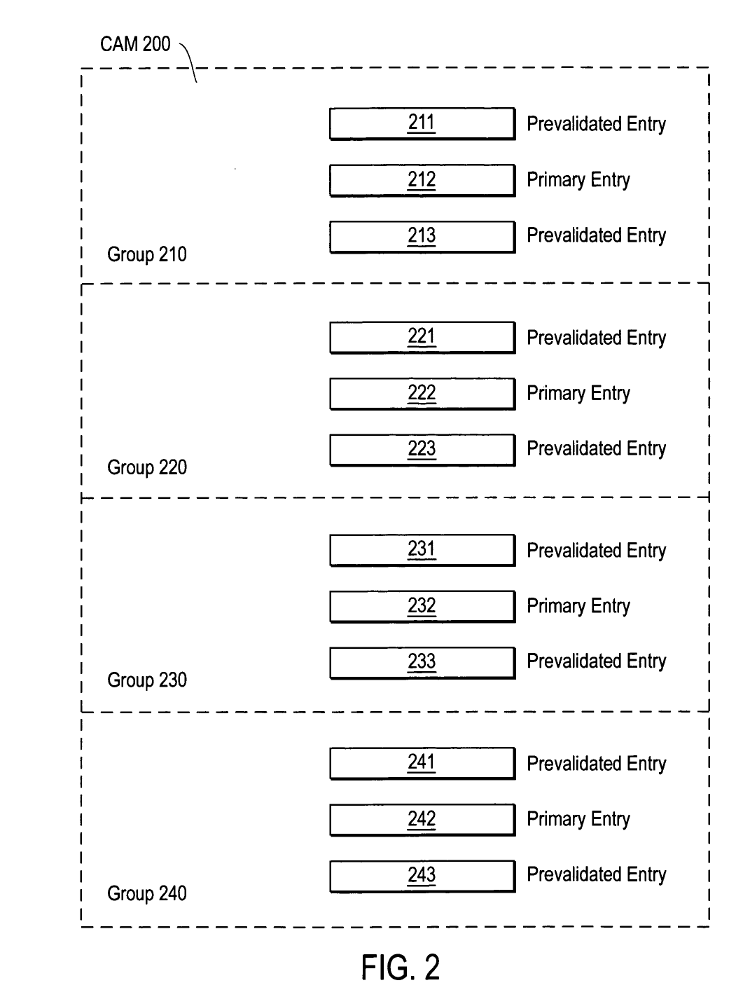

FIG. 2 illustrates an embodiment of a CAM 200 having shared comparison logic. In this embodiment, CAM 200 is a fully-associative translation look-aside buffer having twelve entry locations to store ten-bit virtual addresses. The twelve entry locations are divided into four groups of three entry locations per group. Group 210 includes entry locations 211, 212, and 213. Group 220 includes entry locations 221, 222, and 223. Group 230 includes entry locations 231, 232, and 233. Group 240 includes entry locations 241, 242, and 243.

One entry location per group is designated as a “primary” entry location. For example, in group 210, entry location 212 is the primary entry location. The other entry locations are designated as “prevalidated” entry locations.

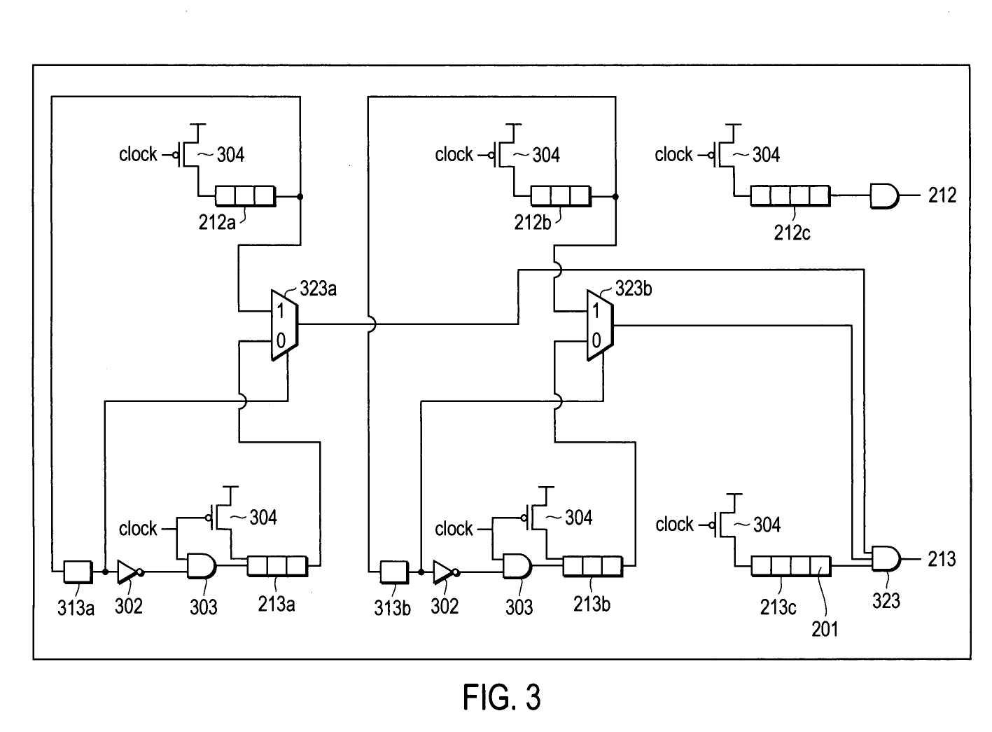

FIG. 3 illustrates primary entry location 212 and prevalidated entry location 213 in greater detail. Each entry location is divided into three portions, an upper portion having three CAM cells 201 to store the three highest order bits of a virtual address, a middle portion having three CAM cells 201 to store the three middle bits, and a lower portion having four CAM cells 201 to store the four lowest bits. For example, entry location 212 is divided into upper portion 212a, middle portion 212b, and lower portion 212c.

Each prevalidated entry location also includes two prevalidation bits. For example, prevalidated entry location includes upper prevalidation bit 313a to indicate whether the upper portion 213a of the prevalidated entry matches the upper portion 212a of the corresponding primary entry, and middle prevalidation bit 313b to indicate whether the middle portion 213b of the prevalidated entry matches the middle portion 212b of the primary entry. One or both prevalidation bits may be set when an entry is loaded into the prevalidated entry location based on comparisons of the upper and middle portions of the address being loaded with the upper and middle portions of the corresponding primary entry location. When a primary entry is evicted, all of the corresponding prevalidation bits are cleared.

The prevalidation bits may used to enable or disable the comparison logic for the upper and middle portions of the prevalidated entry, and to select whether to use the hit signals from the prevalidated entry or the primary entry. For example, if upper prevalidation bit 313a is set, the comparison logic for upper portion 213a is disabled and multiplexer 323a selects the hit signal from upper portion 212a instead of upper portion 213a. The outputs of multiplexers 323a and 323b, as well as the hit signal from lower portion 213c, are input to AND gate 323 to generate the hit signal for prevalidated entry location 213.

To disable the comparison logic, the prevalidation bits may be inverted by inverters 302 and clock gated with AND gates 303 and used as enable inputs to corresponding CAM cells. The clock gating may be used to disable the CAM cells' look-up logic while their hit lines are being precharged by PMOS pull-up transistors 304.

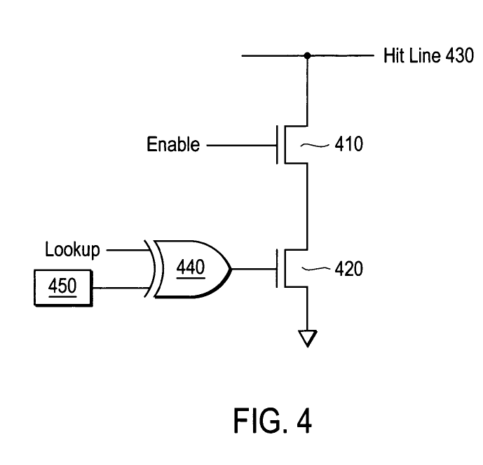

FIG. 4 illustrates the look-up logic of cell 201 of FIG. 2 in greater detail. NMOS pull-down transistors 410 and 420 are connected in series to hit line 430. The gate of pull-down transistor 410 is connected to the clock gated version of the enable input, and the gate of pull-down transistor 420 is connected to the output of XOR gate 440. Therefore, hit line 430 is discharged only if the look-up logic of cell 201 is enabled and the bit of data stored in memory element 450 of cell 201 matches the corresponding bit of look-up data.

Therefore, the sharing of address bits may reduce the dynamic power consumption of CAM 200 by disabling the comparison logic for portions of the addresses of prevalidated entries that match corresponding portions of primary entries.

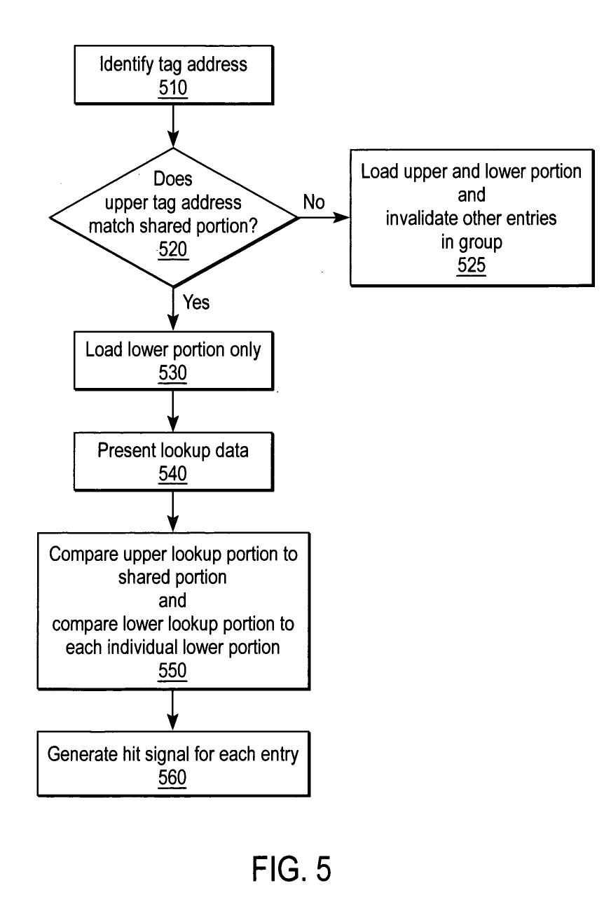

FIG. 5 is a flowchart illustrating an embodiment of a method for sharing comparison logic in a CAM. In this embodiment, the CAM is a set associative cache. In block 510, a tag address is identified to be loaded into the CAM. In block 520, an upper portion of the tag address is compared to a stored upper portion shared within a group of CAM entries. If there is a match, then in block 530, the lower portion is loaded into an entry in the group. If there is not a match, then in block 525, the upper and lower portions are loaded into an entry and the other entries in the group are invalidated. In block 540, look-up data is presented to the CAM. In block 550, an upper portion of the look-up data is compared to the shared upper portions of the CAM entries and the lower portion of the look-up data is compared to each of the individual lower portions of the CAM entries. In block 560, a hit signal is generated for each entry based on the hit signal for the entry's individual lower portion and the shared upper portion entry for the group in which the entry is located.

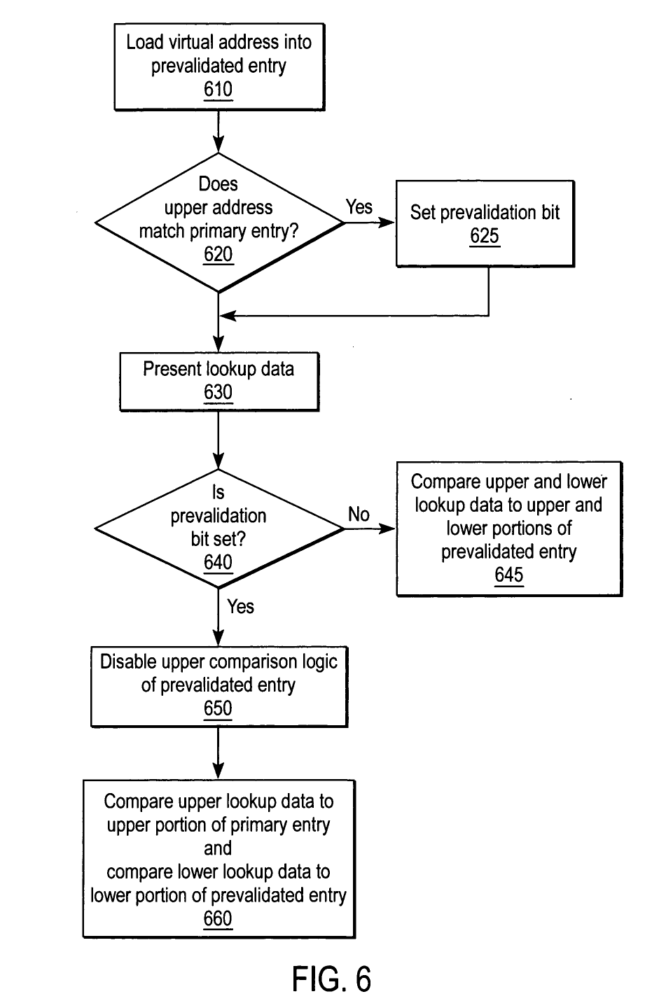

FIG. 6 is a flowchart illustrating another embodiment of a method for sharing comparison logic in a CAM. In this embodiment, the CAM is a fully associative translation look-aside buffer. In block 610, a virtual address is loaded into a prevalidated entry location in the CAM. In block 620, an upper portion of the virtual address is compared to an upper portion of a corresponding primary entry. If there is a match, then in block 625, a prevalidation bit is set. In block 630, look-up data is presented to the CAM. In block 640, the prevalidation bit for the prevalidated entry is checked. If it is not set, then, in block 645, the upper and lower portions of the look-up data are compared to the upper and lower portions of the prevalidated entry to generate a hit signal for the prevalidated entry. If it is set, then, in block 650, the comparison logic for the upper portion of the prevalidated entry is disabled. In block 660, the upper portion of the look-up data is compared to the upper portion of the primary data and the lower portion of the look-up data is compared the lower portion of the prevalidated entry to generate a hit signal for the prevalidated entry.

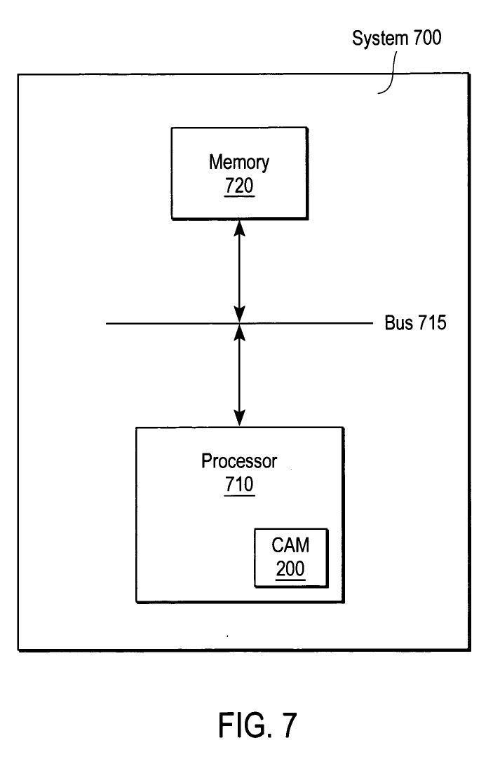

FIG. 7 illustrates an embodiment of a system 700 having a CAM with shared comparison logic. System 700 includes processor 710, which includes CAM 200 or any other CAM in accordance with the present invention. Processor 710 may be any of a variety of different types of processors that include a CAM for any application. For example, the processor may be a general purpose processor such as a processor in the Pentium® Processor Family, the Itanium® Processor Family, or other processor family from Intel Corporation, or another processor from another company.

System 700 also includes memory 720 coupled to processor 710 through bus 715, or through any other buses or components. Memory 720 may be any type of memory capable of storing data to be operated on by processor 710, such as static or dynamic random access memory, semiconductor-based read only memory, or a magnetic optical disk memory. Look-up data to be compared to data stored in CAM 200 may be stored in memory 720 or may represent an address of data in memory 720. System 700 may include any other buses or components in addition to processor 710, bus 715, and memory 720.

Processor 200, processor 100, or any other processor or component designed according to an embodiment of the present invention, may be designed in various stages, from creation to simulation to fabrication. Data representing a design may represent the design in a number of manners. First, as is useful in simulations, the hardware may be represented using a hardware description language or another functional description language. Additionally or alternatively, a circuit level model with logic and/or transistor gates may be produced at some stages of the design process. Furthermore, most designs, at some stage, reach a level where they may be modeled with data representing the physical placement of various devices. In the case where conventional semiconductor fabrication techniques are used, the data representing the device placement model may be the data specifying the presence or absence of various features on different mask layers for masks used to produce an integrated circuit.

In any representation of the design, the data may be stored in any form of a machine-readable medium. An optical or electrical wave modulated or otherwise generated to transmit such information, a memory, or a magnetic or optical storage medium, such as a disc, may be the machine-readable medium. Any of these mediums may “carry” or “indicate” the design, or other information used in an embodiment of the present invention, such as the instructions in an error recovery routine. When an electrical carrier wave indicating or carrying the information is transmitted, to the extent that copying, buffering, or re-transmission of the electrical signal is performed, a new copy is made. Thus, the actions of a communication provider or a network provider may be making copies of an article, e.g., a carrier wave, embodying techniques of the present invention.

Thus, techniques for sharing comparison logic in a CAM have been disclosed. While certain embodiments have been described, and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. For example, the number of entries sharing the match logic in an embodiment like that of FIG. 1, or the number of prevalidated entries per primary entry in an embodiment like FIG. 2 may vary within the scope of the present invention, and may be based on timing or any other considerations. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A content addressable memory comprising:
a first entry location including:
a first plurality of cells to store a high order portion of a first entry; and
first comparison logic to indicate whether a first condition is true, where the first condition is whether a first portion of look-up data matches the high order portion of the first entry;
a second entry location including:
a second plurality of cells to store the low order portion of a second entry;
second comparison logic to indicate whether a second condition is true, where the second condition is whether a second portion of look-up data matches the low order portion of the second entry; and
first match logic to indicate whether both the first condition and the second condition are true.

2. A content addressable memory of claim 1 wherein the first entry location also includes:
a third plurality of cells to store the low order portion of the first entry;
third comparison logic to indicate whether a third condition is true, where the third condition is whether the second portion of look-up data matches the low order portion of the first entry; and
second match logic to indicate whether the both the first condition and the third condition are true.

3. The content addressable memory of claim 2, wherein:
the second entry location also includes:
a fourth plurality of cells to store the high order portion of the second entry;
fourth comparison logic to indicate whether a fourth condition is true,
where the fourth condition is whether the first portion of look-up data matches the high order portion of the second entry; and
the first match logic is also to indicate whether both the second condition and the fourth condition are true.

4. The content addressable memory of claim 3, wherein the second entry location also includes:
selection logic to select whether the indicator from the first comparison logic or the indicator from the fourth comparison logic is used by the first match logic; and
a prevalidation bit to store a value to control the selection logic and disable the fourth comparison logic if the indicator from the first comparison logic is selected.

5. The content addressable memory of claim 4, wherein the first comparison logic is also to:
indicate whether a fifth condition is true when the second entry is loaded into the second entry location, where the fifth condition is whether the high order portion of the second entry matches the high order portion of the first entry; and
set the value of the prevalidation bit to select the indicator from the first comparison logic if the fifth condition is true.

6. A method comprising:
comparing a high order portion of look-up data to a shared high order portion of stored data, where the shared high order portion is shared by a plurality of entry locations in a content addressable memory;
comparing a low order portion of look-up data to a low order portion of each of the plurality of entry locations; and
generating a plurality of hit signals, one for each of the plurality of entry locations, each based on the comparison to the shared high order portion of stored data.

7. A method comprising:
comparing a high order portion of look-up data to a high order portion of a first entry in a content addressable memory;
disabling the logic to compare the high order portion of look-up date to the high order portion of a second entry in the content addressable memory if a prevalidation bit is set;
comparing a low order portion of look-up data to a low order portion of the second entry location; and
generating a hit signal for the second entry location based on the comparison to the high order portion of the first entry and the low order portion of the second entry.

8. A system comprising:
a dynamic random access memory; and
a processor including a content addressable memory having:
a first entry location including:
a first plurality of cells to store a high order portion of a first entry; and
first comparison logic to indicate whether a first condition is true, where the first condition is whether a first portion of look-up data matches the high order portion of the first entry;
a second entry location including:
a second plurality of cells to store the low order portion of a second entry;
second comparison logic to indicate whether a second condition is true, where the second condition is whether a second portion of look-up data matches the low order portion of the second entry; and
first match logic to indicate whether both the first condition and the second condition are true.
